(19) United States
(12) Patent Application Publication
(10) Pub. No.: US 2021/0029451 A1
(43) Pub. Date: Jan. 28, 2021

(54) INTEGRATED SLIDING BIAS AND OUTPUT LIMITER

(71) Applicant: Earlens Corporation, Menlo Park, CA (US)

(72) Inventors: Kelly FITZ, Eden Prairie, MN (US); Brendan LARKIN, Menlo Park, CA (US); Xavier CHABOT, Dublin, CA (US)

(21) Appl. No.: 17/066,345

(22) Filed: Oct. 8, 2020

Related U.S. Application Data
(63) Continuation of application No. PCT/US2019/026361, filed on Apr. 8, 2019.
(60) Provisional application No. 62/654,822, filed on Apr. 9, 2018.

(51) Int. Cl. H04R 3/04; H04R 25/00; G10L 21/02

(52) U.S. Cl. CPC H04R 3/04; H04R 2225/025; G10L 21/02; H04R 25/505

(57) ABSTRACT

In devices using the present invention, audible artifacts may be reduced or eliminated by designing the system such that the sliding bias level is fed back to an output limiter so that a single algorithm manages all saturation artifacts. In embodiments of the invention, this feedback loop will eliminate the need for a second output limiter.

### CROSS-REFERENCE

This application is a continuation of PCT Application No. PCT/US19/26361, filed Apr. 8, 2019; which claims the benefit of U.S. Provisional Application No. 62/654,822, filed Apr. 9, 2018; the entire contents of which are herein incorporated by reference.

### BACKGROUND OF THE INVENTION

In hearing aids, such as the contact hearing aids available from Earlens Corporation, sliding bias algorithms may be used to lower the power consumption by, for example, manipulating the DC offset of the audio signal before it is input to a modulator. In these devices, an algorithm is used to vary a bias, including a negative bias, according to the output sound level. By varying the bias amount it is possible to manage the power consumption by the output device, e.g. a laser. A similar design may be used in a class A amplifier, where the bias voltage is lowered when the signal is small, thereby reducing the wasted power. This is particularly beneficial in systems, such as light-driven contact hearing aids, where, as in a class A amplifier, the bias current flows even when there is no output audio signal.

However, the use of sliding bias algorithms may generate artifacts which are audible to the user, such as, for example, saturation artifacts. In prior systems, saturation artifacts may have been reduced or eliminated by using a first output limiter to attenuate signals that would exceed the momentary signal intensity limit, along with a second limiter that similarly attenuates signals that would exceed the digital saturation level.

### SUMMARY OF THE INVENTION

In devices using the present invention, audible artifacts may be reduced or eliminated by designing the system such that the sliding bias level is fed back to an output limiter so that a single algorithm manages all saturation artifacts. In embodiments of the invention, this feedback loop will eliminate the need for a second output limiter.

### BRIEF DESCRIPTION OF THE DRAWINGS

The foregoing and other objects, features and advantages of embodiments of the present inventive concepts will be apparent from the more particular description of preferred embodiments, as illustrated in the accompanying drawings in which like reference characters refer to the same or like elements. The drawings are not necessarily to scale, emphasis instead being placed upon illustrating the principles of the preferred embodiments.

FIG. 1 is a cutaway view of an ear canal showing a light-coupled contact hearing system for use in the present invention, wherein at least a portion of the contact hearing system is positioned in the ear canal.

FIG. 2 is a cutaway view of an ear canal showing an inductively-coupled contact hearing system according to the present invention, wherein at least a portion of the contact hearing system is positioned in the ear canal.

FIG. 3 is a block diagram of a light-coupled contact hearing system for use in the present invention.

FIG. 4 is a block diagram of an inductively-coupled contact hearing system for use in the present invention.

FIG. 5 is a top view of an inductively-coupled contact hearing device for use in systems and methods according to the present invention.

FIG. 6 is a bottom view of an inductively-coupled contact hearing device for use in systems and methods according to the present invention.

FIG. 7 is a cutaway view of an ear canal illustrating the positioning of an inductively-coupled contact hearing device for use in systems and methods according to the present invention.

FIG. 8 is a system wherein a data transmission device (e.g., a cell phone) is transmitting a data stream to a contact hearing system including an ear tip and a contact hearing device according to the present invention.

FIG. 9 is a sliding bias control circuit according to the present invention.

### DETAILED DESCRIPTION OF THE INVENTION

In devices utilizing the present invention, such as contact hearing systems, when the signal level changes, specifically, when it increases, the (e.g., negative) bias level needs to increase (e.g., towards 0) in order to handle the larger input signal without saturation. If the bias level does not rise fast enough, the output signal will be distorted. Distortion may include distortion caused by saturation, where the output is clipped. In the present invention, the problem of bias levels that do not rise fast enough is addressed by a system that employs an output limiter that applies brief attenuation to prevent sudden saturation. In embodiments of the invention, the limiting level is controlled by the current bias level. In embodiments of the invention, the output limiter, rather than managing only digital saturation, and therefore employing a fixed limit threshold, precedes the sliding bias in the signal processing pipeline. In embodiments of the invention, the output limiter threshold will vary with the sliding bias. Designs such as those described will mitigate digital saturation. Designs such as those described with also mitigate underflow due to sudden signal onsets and low sliding bias levels.

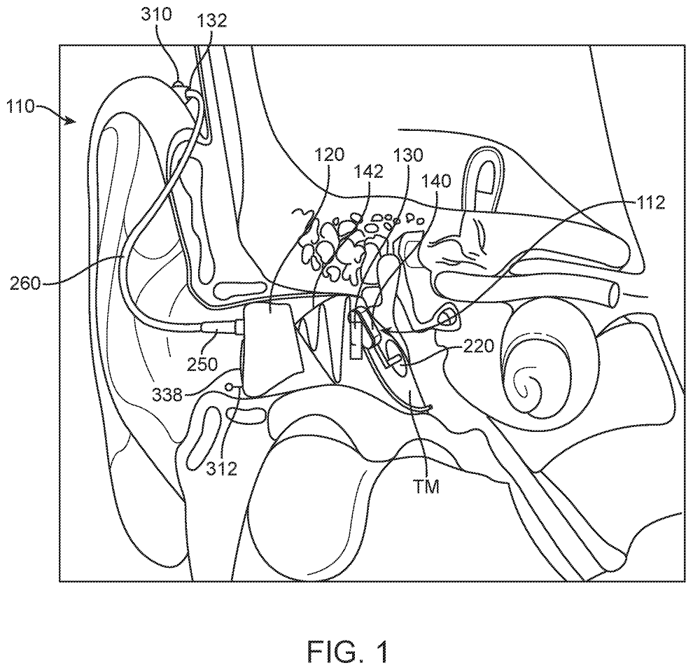

FIG. 1 is a cutaway view of an ear canal showing a light-coupled contact hearing system for use in the present invention, wherein at least a portion of the contact hearing system is positioned in the ear canal. FIG. 1 is a cutaway view of an ear canal showing a contact hearing system 110 for use in the present invention, wherein the contact hearing system 110 is positioned in the ear canal. In embodiments of the invention, contact hearing system 110 may comprise a contact hearing system using light to transmit information and/or power from the ear tip to the contact hearing device. In FIG. 1, contact hearing system 110 includes audio processor 132, which audio processor may include at least one external microphone 310. Audio processor 132 may be connected to an ear tip 120 by cable 260, which is adapted to transmit signals from audio processor 132 to ear tip 120. Taper tube 250 may be used to support cable 260 at ear tip 120. Ear tip 120 may further include canal microphone 312 and acoustic vent 338. Ear tip 120 may be a light tip which radiates light pulses 142 in response to signals from audio processor 132. Light or other signals radiated by ear tip 120 may be received by contact hearing device 112, which may comprise photodetector 130, microactuator 140, and umbo lens 220. Contact hearing device 112 may be positioned on tympanic membrane TM.

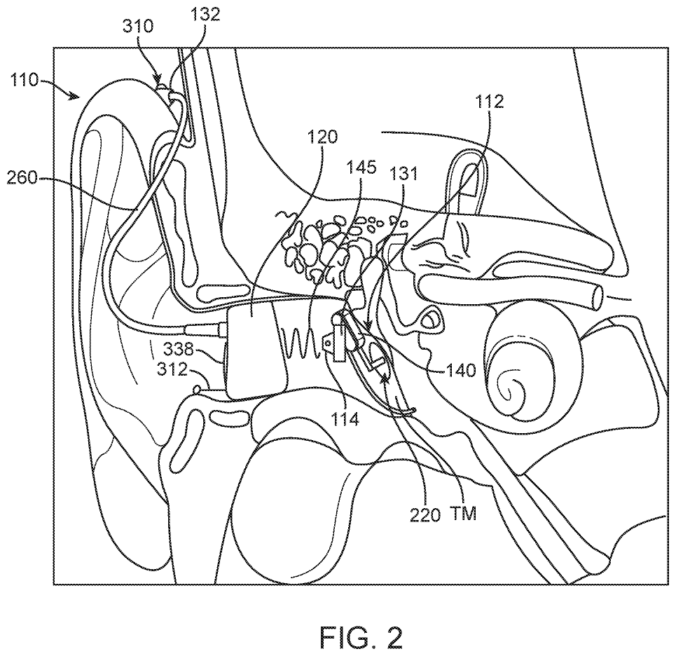

FIG. 2 is a cutaway view of an ear canal showing a contact hearing system 110 for use in systems and methods according to the present invention, wherein at least a portion of the contact hearing system 110 is positioned in the ear canal. In embodiments of the invention, contact hearing system 110 may comprise a contact hearing system using electromagnetic waves 145 to transmit information and/or power from ear tip 120 to the contact hearing device 112. In embodiments of the invention, contact hearing system 110 may comprise a contact hearing system using inductive coupling to transmit information and/or power from ear tip 120 to contact hearing device 112. In FIG. 2, contact hearing system 110 may include audio processor 132, which audio processor may include at least one external microphone 310. Audio processor 132 may be connected to an ear tip 120 by cable 260, which is adapted to transmit signals from audio processor 132 to ear tip 120. Ear tip 120 may further include canal microphone 312 and at least one acoustic vent 338. Ear tip 120 may be an ear tip which radiates electromagnetic waves 145 in response to signals from audio processor 132. Electromagnetic signals radiated by ear tip 120 may be received by contact hearing device 112, which may comprise receive coil 131, microactuator 140, and umbo lens 220. Contact hearing device 112 may further include grasping tab 114.

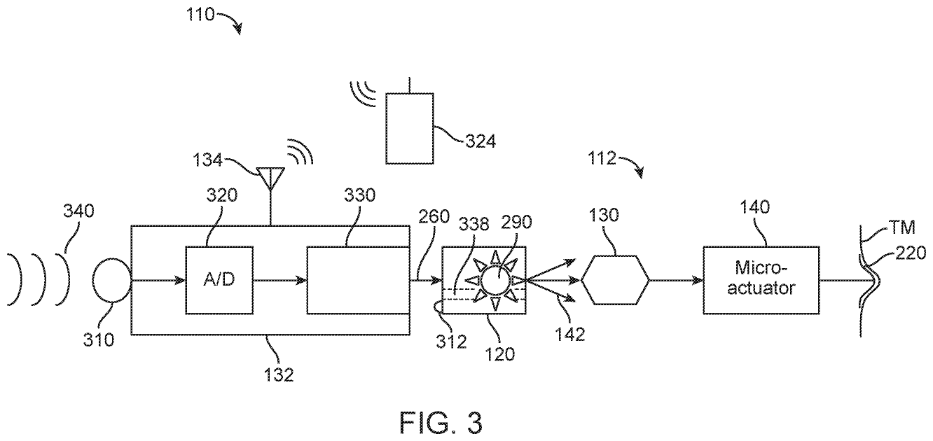

FIG. 3 is a block diagram of a light-coupled contact hearing system for use in the present invention, wherein the contact hearing system 110 may be positioned in the ear canal of a user. In embodiments of the invention, contact hearing system 110 may include one or more external communication and control devices 324, which may also act as a data transmission device 400. In embodiments of the invention, audio processor 132 may communicate with external communication and control devices 324 by, for example, using audio processor antenna 134. In FIG. 3, contact hearing system 110 may include audio processor 132, ear tip 120, and contact hearing device 112. Audio processor 132 may include external microphone 310, audio processor antenna 134, analog to digital converter 320, and signal processor 330. Audio processor 132 may be connected to ear tip 120 by cable 260. Ear tip 120, which may also be referred to as a light tip, may include a light source 290 (which may be a laser), acoustic vent 338, and canal microphone 312. Signals, including data and power, may be transmitted from ear tip 120 to contact hearing device 112 using light, such as light pulses 142. Contact hearing device 112 may include photodetector 130, microactuator 140, and umbo lens 220. Umbo lens 220 may be positioned to contact tympanic membrane TM. In FIG. 3, acoustic input 340 (which may be an ambient sound or an audible sound) may be received by external microphone 310 of audio processor 132, which then processes the received sound by passing it through processing circuitry, which may include analog to digital converter 320 and signal processor 330.

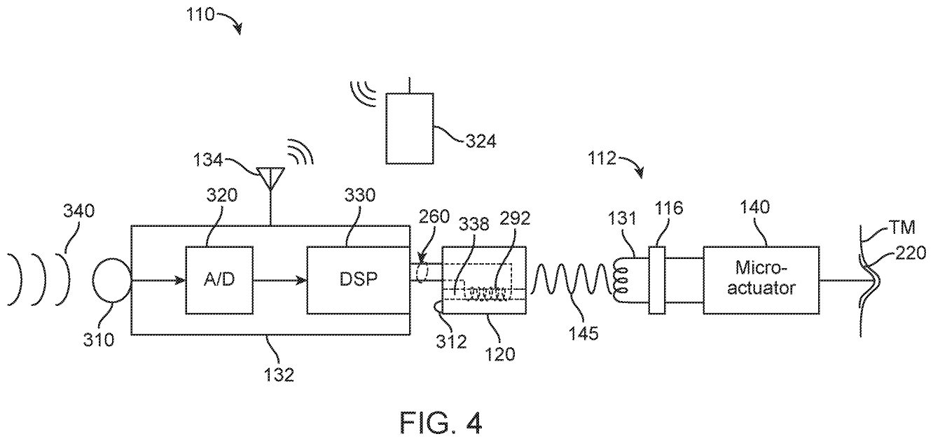

FIG. 4 is a block diagram of a contact hearing system 110 for use in the present invention. In embodiments of the invention, at least a portion of contact hearing system 110 is positioned in the ear canal of a user. In FIG. 4, acoustic input 340 may be received by external microphone 310 of audio processor 132, which then processes the received sound by passing it through processing circuitry, which may include analog to digital converter 320 and signal processor 330. The output of audio processor 132 may be transmitted to an ear tip 120 by cable 260. Signals transmitted to ear tip 120 may then be transmitted to contact hearing device 112 by, for example, causing transmit coil 292 to radiate electromagnetic waves 145. In embodiments of the invention, contact hearing device 112 may include receive coil 131, demodulator 116, microactuator 140, and umbo lens 220. Information contained in electromagnetic waves 145 received by receive coil 131 may be transmitted through demodulator 116 to microactuator 140, moving umbo lens 220. In embodiments of the invention, the signal transmitted to ear tip 120 may be a signal representative of the received audio signal which may then be transmitted to contact hearing device 112. In embodiments of the invention transmit coil 292 may be wound around a solid core, without an acoustic vent. In embodiments of the invention, transmit coil 292 may be wound around an acoustic vent 338 in ear tip 120. In embodiments of the invention, acoustic vent 338 may be formed as a passage through a ferrite material. In embodiments of the invention, transmit coil 292 may be wound around ferrite material positioned in ear tip 120. In embodiments of the invention, contact hearing system 110 may include one or more external communication and control devices 324, such as, for example, a cell phone. In embodiments of the invention, audio processor 132 may communicate with external communication and control devices 324 by, for example, using audio processor antenna 134. Umbo lens 220 may be positioned to contact tympanic membrane TM. Ear tip 120 may include canal microphone 312.

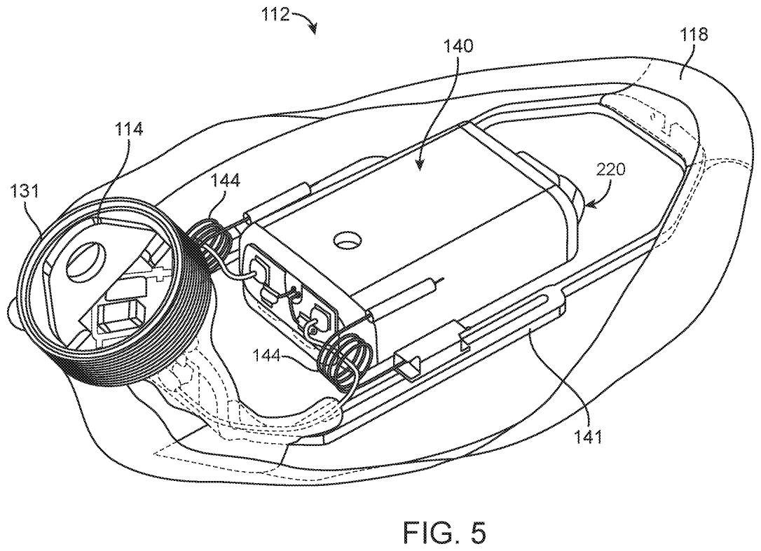

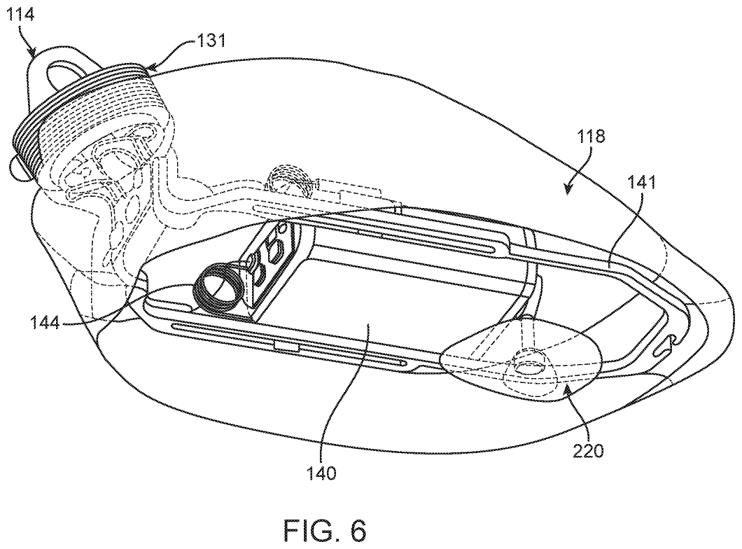

FIG. 5 is a top view of a contact hearing device 112 according to the present invention. FIG. 6 is a bottom view of a contact hearing device 112 according to the present invention. The contact hearing device 112 illustrated in FIGS. 5 and 6 includes a receive coil 131, a microactuator 140, an umbo lens 220, a support structure 141, and springs 144. In the embodiment illustrated in FIGS. 5 and 6, microactuator 140 is connected to support structure 141 by springs 144. In embodiments of the invention, contact hearing device 112 may further include a sulcus platform 118, which may also be referred to as a mounting platform, connected to support structure 141 and adapted to assist in positioning contact hearing device 112 in the ear canal of a user. In embodiments of the invention, contact hearing device 112 may further include grasping tab 114.

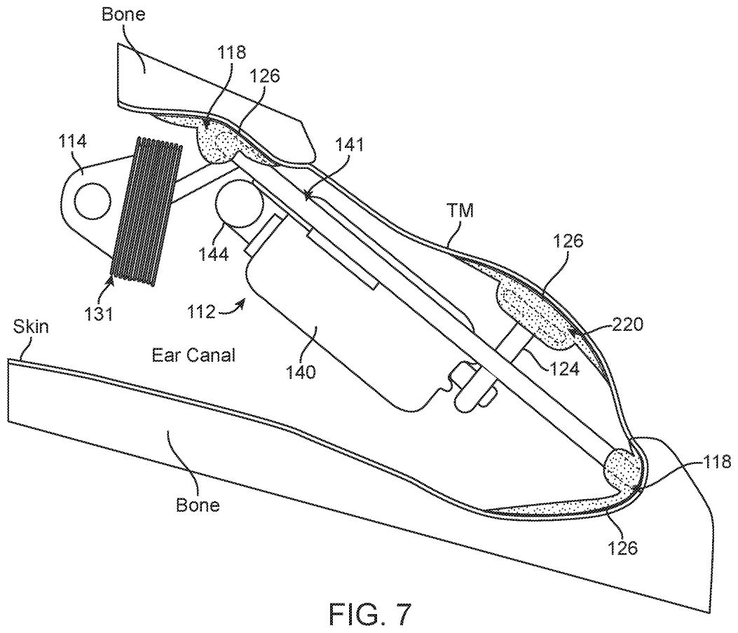

FIG. 7 is a cutaway view of an ear canal illustrating the positioning of a contact hearing device 112 according to the present invention. In the embodiment of FIG. 7, contact hearing device 112 is positioned at a medial end of the ear canal, proximate the tympanic membrane of the user. Contact hearing device 112 includes a receive coil 131 positioned at a proximal end thereof. In embodiments of the invention, receive coil 131 may be positioned to receive signals from an ear tip (not shown) positioned in the ear canal lateral to the position of contact hearing device 112. In embodiments of the invention, signals received by receive coil 131 may be transmitted to microactuator 140 to move drive post 124 which is connected to the user's tympanic membrane through umbo lens 220. Umbo lens 220 may be in direct physical contact with the tympanic membrane or a thin layer of oil 126 may be used between umbo lens 220 and the user's tympanic membrane. Sulcus platform 118 may be used to properly position contact hearing device 112 in the user's ear canal through contact with a skin layer which lines the ear canal. Sulcus platform 118 may be in direct contact with the skin of the ear canal, or a thin layer of oil 126 may be used between sulcus platform 118 and the skin of the ear canal. In embodiments of the invention, contact hearing device 112 may further include support structure 141, grasping tab 114 and springs 144.

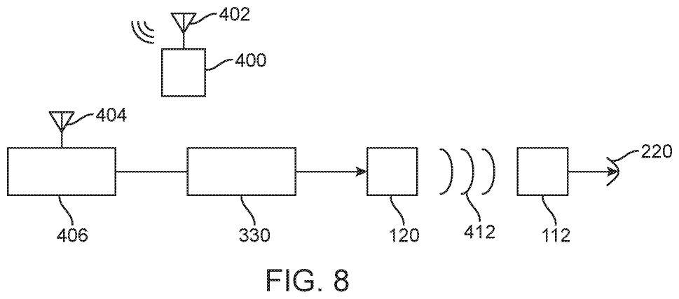

FIG. 8 is a system wherein a data transmission device such as a cell phone is transmitting a data stream to a contact hearing system including an ear tip and a contact hearing device according to the present invention. In FIG. 8, data transmission device 400 includes a data transmission antenna 402 from which data, such as streaming audio, may be transmitted to a receiver antenna 404, which is connected to receiver 406. The output of receiver 406 may be transmitted to signal processor 330. Signal processor 330 may include a sampling rate converter and a digital signal processor. The output of signal processor 330 may be transmitted to ear tip 120, which may transmit the output of signal processor 330 via transmitted signal 412. Transmitted signal 412 may comprise light pulses or other electromagnetic waves, including radio waves and inductively-coupled waves. Transmitted signal 412 may be received by contact hearing device 112 and converted to mechanical energy to drive a tympanic membrane through, for example, umbo lens 220.

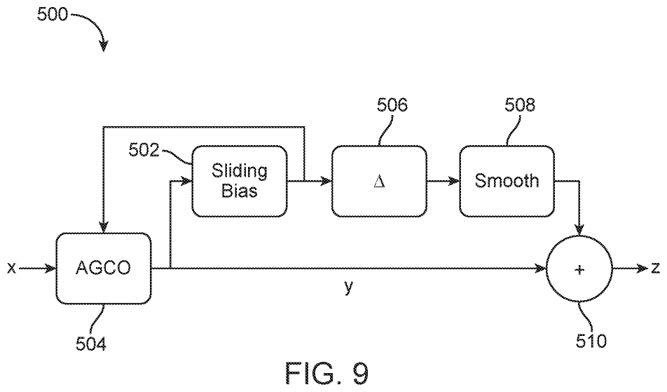

FIG. 9 is a sliding bias control circuit 500 according to the present invention. In the embodiment of FIG. 9, the output of sliding bias circuit 502 may be fed back to the automatic gain control (AGCO) circuit 504 such that the amount of gain applied to the input signal X is a function of the level of the sliding bias signal.

In embodiments of the invention, the output of sliding bias circuit 502 may be delayed by, for example, delay circuit 506 to provide AGCO circuit 504 with time to react to the feedback from bias circuit without increasing the latency of the system. In embodiments of the invention, the output of sliding bias circuit 502 may be delayed, by, for example, delay circuit 506 to provide AGCO circuit 504 with time to react to the feedback from sliding bias circuit 502 without increasing the latency of the audio path through the system. In embodiments of the invention, the output of bias circuit 502 may be delayed to reduce latency of the system, improving sound quality. In embodiments of the invention, the output of sliding bias circuit 502 may be delayed to provide AGCO circuit 504 with time to react to the feedback from the bias circuit. In embodiments of the invention, the output of bias circuit 506 is always non-positive.

In embodiments of the invention, the input X to sliding bias control circuit 500 may be an audio signal. In embodiments of the invention, the input X to sliding bias control circuit 500 may be an audio signal which is an output of external microphone 310. In embodiments of the invention, the input X to sliding bias control circuit 500 may be an audio signal which is an output of analog to digital converter 320. In embodiments of the invention, external microphone 310 may be connected to an A-to-D converter 320 with the input X as the output of A-to-D converter 320. In embodiments of the invention, the input X to sliding bias control circuit 500 may be an audio signal which is an output of signal processor 330, which may be a digital signal processor. In embodiments of the invention, sliding bias control circuit 504 may include an automatic gain control circuit 504 which may limit the gain applied to the input X. In embodiments of the invention, automatic gain control circuit 504 may attenuate input X if it is too large. In embodiments of the invention, automatic gain control circuit 504 may attenuate input X if it is too large (e.g., in the event that X is an audio signal representing a loud sound).

In embodiments of the invention, sliding bias control circuit 500 may include a sliding bias circuit 502. In embodiments of the invention, automatic gain control circuit 504 may receive an input signal from sliding bias circuit 502 which may be used to, for example, define a threshold beyond which automatic gain control circuit 504 limits the gain applied to input X. In embodiments of the invention, sliding bias circuit 502 may be used to control the level of bias added to the output Y of automatic gain control circuit 504. In embodiments of the invention, sliding bias circuit 504 may shift the bias such that a smaller (e.g., lower or more negative) bias is added to output Y when the input X is a small signal. In embodiments of the invention, sliding bias circuit 504 may shift the bias such that a larger bias is added to output Y when the input X signal is large, to, for example, prevent output Y from being clipped.

In embodiments of the invention, sliding bias control circuit 500 may include delay circuit 506, which may be used to delay the output of sliding bias circuit 502 such that the output of sliding bias circuit 502 reaches summing circuit 510 before the output Y of automatic gain control circuit 504. In embodiments of the invention, the delay introduced by delay circuit 506 is intended to make sure that the AGCO 504 has applied the desired level change before the bias is applied by SB 502. Note that the delay 506 is applied to the control signal and therefore it does not affect the overall latency of the sound signal. In embodiments of the invention, there may be a delay in resetting the threshold value in automatic gain control circuit 504, and the delay introduced by delay circuit 506 may compensate for that delay.

In embodiments of the invention, sliding bias control circuit 500 may include smoothing circuit 508. In embodiments of the invention, smoothing circuit 508 may be used to, for example, integrate the output of sliding bias circuit 502 to smooth out changes in the output of sliding bias circuit 502. In embodiments of the invention, smoothing circuit 508 may be used to ramp the output of sliding bias circuit 502 from one value to another, thus preventing abrupt changes in the value of the output of sliding bias circuit 502 which might be audible to a user.

In embodiments of the invention, sliding bias control circuit 500 may include summing circuit 501. In embodiments of the invention, summing circuit 501 may be used to sum the output of automatic gain control circuit 504 to the output of sliding bias circuit 502 in order to add a bias (which may be a negative bias) to output Y of automatic gain control circuit 504 and generate output Z of sliding bias control circuit 500. In embodiments of the invention, summing circuit 501 may be used to sum the output of automatic gain control circuit 504 to the delayed and smoothed output of sliding bias circuit 502 in order to add a bias (which may be a negative bias) to output Y of automatic gain control circuit 504 and generate output Z of sliding bias control circuit 500.

In embodiments of the invention, the invention may be described by the following equations.
xₙ is input to AGCO at Tn: xₙ=x(Tₙ₋₁≤t<Tₙ) (a block of input samples)
Sₙ=max abs xₙ
Limit Lₙ=1+Bₙ₋₁* (Bₙ₋₁* is bias transmitted back to AGCO in block n−1). In embodiments of the invention the limit may be transmitted back to the AGCO.
Gₙ=min(Lₙ/Sₙ, 1): attenuation needed to ensure that xₙ doesn't ever exceed Lₙ

AGCO Gain g(t):

g(Tₙ₋₁≤t<Tₙ)=f(t:g(Tₙ₋₁),Gₙ₋₁,Gₙ) s.t. g(Tₙ)≤Gₙ(see below)

yₙ=g(Tₙ₋₁≤t<Tₙ)*xₙ₋₁

Bias:

zₙ=yₙ+bₙ
Where bₙ=lin(Bₙ₋₂, Bₙ₋₁) [In this equation lin(A,B) means linear interpolation from A to B.
Bₙ computed (updated) from yₙ

Bₙ*=min(Bₙ,Bₙ₋₁)

About f(t: g(Tₙ₋₁), Gₙ₋₁, Gₙ):

G_{Tgt,n}=min(G_{n_1},Gₙ)

if G_{Tgt,n}<g(Tₙ₋₁₎):
f(t) is lin(gₙ₋₁, G_{Tgt,n})

else:
f(t) releases (exponentially) toward G_{Tgt,n}

Embodiments of the present invention may be directed to a method of controlling a hearing aid circuit including a sliding bias circuit, wherein the method includes the steps of: receiving an audio input signal; adjusting the gain of the input signal; transmitting the gain adjusted input signal to a sliding bias calculator and a summing circuit; wherein the level of gain applied to the input signal is a function of the output of the sliding bias circuit. In methods according to the present invention, the method further includes the step of delaying the output of the sliding bias circuit. In methods according to the present invention, the method further includes the step of adding the delayed output of the sliding bias circuit to the output of the automatic gain control circuit to create an output which is gain controlled and includes a bias component.

Embodiments of the present invention include a contact hearing system including a sliding bias circuit, wherein the sliding bias circuit includes an input; an automatic gain control circuit connected to the input; a sliding bias calculator connected to the output of the automatic gain control circuit; an output of the sliding bias calculator connected to a control input of the automatic gain control circuit such that the output of the automatic gain control circuit is a function of the output of the sliding bias calculator. Embodiments of the present invention may further include a delay circuit connected to the output of the sliding bias calculator. Embodiments of the present invention may further include a summing circuit connected to an output of the delay circuit and the output of the automatic gain control circuit, wherein the output of the summing circuit is a gain modulated audio signal including a bias component.

### Definitions

Audio Processor—A system for receiving and processing audio signals. Audio processors may include one or more microphones adapted to receive audio which reaches the user's ear. The audio processor may include one or more components for processing the received sound. The audio processor may include digital signal processing electronics and software which are adapted to process the received sound. Processing of the received sound may include amplification of the received sound. The output of the audio processor may be a signal suitable for driving a laser located in an ear tip. The output of the audio processor may be a signal suitable for driving an antenna located in an ear tip. The output of the audio processor may be a signal suitable for driving an inductive coil located in an ear tip. Audio processors may also be referred to as behind the ear units or BTEs.

Contact Hearing System—A system including a contact hearing device, an ear tip and an audio processor. Contact hearing systems may also include an external communication device. An example of such system is an Earlens hearing-aid that transmits audio signal by laser to a contact hearing device which is located on or adjacent to the ear drum. The contact hearing system may also be referred to as a smart lens.

Contact Hearing Device—A tiny actuator connected to a customized ring-shaped support platform that floats on the ear canal around the eardrum, where the actuator directly vibrates the eardrum causing energy to be transmitted through the middle and inner ears to stimulate the brain and produce the perception of sound. The contact hearing device may comprise a photodetector, a microactuator connected to the photodetector, and a support structure supporting the photodetector and microactuator. The contact hearing device may comprise an antenna, a microactuator connected to the antenna, and a support structure supporting the antenna and microactuator. The contact hearing device may comprise a coil, a microactuator connected to the coil, and a support structure supporting the coil and microactuator. The contact hearing device may also be referred to as a Tympanic Contact Actuator (TCA), a Tympanic Lens, a Tympanic Membrane Transducer (TMT), or a smart lens.

Ear Tip—A structure designed to be placed into and reside in the ear canal of a user, where the structure is adapted to receive signals from an audio processor and transmit signals to the user's tympanic membrane or to a device positioned on or near the user's tympanic membrane (such as, for example, a contact hearing device). In one embodiment of the invention, the signals may be transmitted by light, using, for example, a laser positioned in the light tip. In one embodiment of the invention, the signals may be transmitted using radio frequency, using, for example, an antenna connected to the Ear Tip. In one embodiment of the invention, the signal may be transmitted using inductive coupling, using, for example, a coil connected to the ear tip. The ear tip may also be referred to as a light tip, magnetic tip, or mag tip.

Light-Driven Hearing Aid System—A contact hearing system wherein signals are transmitted from an ear tip to a contact hearing device using light. In a light driven hearing system, light (e.g. laser light) may be used to transmit information, power, or both information and power to a contact hearing device.

RF-Driven Hearing Aid System—A contact hearing system wherein signals are transmitted from an ear tip to a contact hearing device using radio frequency electromagnetic radiation. In an RF driven hearing system, electromagnetic radiation may be used to transmit information, power, or both information and power from the ear tip to the contact hearing device.

Inductively-Driven Hearing Aid System—A contact hearing system wherein signals are transmitted from an ear tip to a contact hearing device using inductive coupling. In an inductively driven hearing system, magnetic waves may be used to transmit information, power, or both information and power from the ear tip to the contact hearing device.

Light Tip—An ear tip adapted for use in a light driven hearing aid system. A light tip may include a laser.

Mag Tip—An ear tip adapted for use in an inductively driven hearing aid system. The mag tip may include an inductive transmit coil.

While the preferred embodiments of the devices and methods have been described in reference to the environment in which they were developed, they are merely illustrative of the principles of the present inventive concepts. Modification or combinations of the above-described assemblies, other embodiments, configurations, and methods for carrying out the invention, and variations of aspects of the invention that are obvious to those of skill in the art are intended to be within the scope of the claims. In addition, where this application has listed the steps of a method or procedure in a specific order, it may be possible, or even expedient in certain circumstances, to change the order in which some steps are performed, and it is intended that the particular steps of the method or procedure claim set forth herebelow not be construed as being order-specific unless such order specificity is expressly stated in the claim.

### REFERENCE NUMBERS

| Number | Element |
|---|---|
| 110 | Contact Hearing System |
| 112 | Contact Hearing Device |
| 114 | Grasping Tab |
| 116 | Demodulator |
| 118 | Sulcus Platform |
| 120 | Ear Tip/Light Tip/Mag Tip |
| 124 | Drive Post |
| 126 | Oil Layer |
| 130 | Photodetector |
| 131 | Receive Coil |
| 132 | Audio Processor |
| 134 | Audio Processor Antenna |
| 140 | Microactuator |
| 141 | Support Structure |
| 142 | Light Pulses |
| 145 | Electromagnetic Waves |
| 144 | Springs |
| 220 | Umbo Lens |
| 250 | Taper Tube |
| 260 | Cable |
| 290 | Light Source |
| 292 | Transmit Coil |
| 310 | External Microphone |
| 312 | Canal Microphone |
| 320 | Analog to Digital Converter |
| 324 | External Communication and Control Device |
| 330 | Signal Processor |
| 338 | Acoustic Vent |
| 340 | Acoustic Input (Audible Sound) |
| 400 | Data Transmission Device |
| 402 | Data Transmission Antenna |
| 404 | Receiver Antenna |
| 406 | Receiver |
| 412 | Transmitted Signal |
| 500 | Sliding Bias Control Circuit |
| 502 | Sliding Bias Circuit |
| 504 | Automatic Gain Control (AGCO) Circuit |
| 506 | Delay Circuit |
| 508 | Smoothing Circuit |
| 510 | Summing Circuit |
| TM | Tympanic Membrane |

1. A method of controlling a hearing aid circuit including a sliding bias circuit, wherein the method comprises the steps of:
receiving an audio input signal;
adjusting a gain of the input signal; and
transmitting the gain-adjusted input signal to a sliding bias calculator and a summing circuit,
wherein a level of the gain applied to the input signal is a function of an output of the sliding bias calculator.

2. A method according to claim 1, further including the steps of:
delaying the output of the sliding bias calculator.

3. A method according to claim 2, further including the step of:
adding the delayed output of the sliding bias calculator to the output of the automatic gain control circuit to create an output which is gain-controlled and includes a bias component.

4. A contact hearing system including a sliding bias circuit, wherein the sliding bias circuit comprises:
an input;
an automatic gain control circuit connected to the input;
a sliding bias calculator connected to the output of the automatic gain control circuit; and
an output of the sliding bias calculator connected to a control input of the automatic gain control circuit, such that the output of the automatic gain control circuit is a function of the output of the sliding bias calculator.

5. A contact hearing system according to claim 4, further comprising:
a delay circuit connected to the output of the sliding bias calculator.

6. A contact hearing system according to claim 5, further comprising:
a summing circuit connected to an output of the delay circuit and the output of the automatic gain control circuit, wherein the output of the summing circuit is a gain-modulated audio signal including a bias component.
